(19) United States
(12) Patent Application Publication
(10) Pub. No.: US 2025/0278538 A1
(43) Pub. Date: Sep. 4, 2025

(54) Electric Distribution Digital Twin- Actual-time Dynamic System Performance

(71) Applicant: Open Access Technology International, Inc., Minneapolis, MN (US)

(72) Inventors: Sasan Mokhtari, Eden Prairie, MN (US); Ebrahim Vaahedi, West Vancouver (CA); Khashayar Nodehi Fard Haghighi, Mapoe Grove, MN (US); Rakesh Panda, Sangaleisasan (IN); Carlos Gonzalez-Perez, Maple Grove, MN (US); Jaspreet Singh, Rogers, MN (US)

(73) Assignee: Open Access Technology International, Inc., Minneapolis, MN (US)

(21) Appl. No.: 19/066,747

(22) Filed: Feb. 28, 2025

Related U.S. Application Data
(60) Provisional application No. 63/560,018, filed on Mar. 1, 2024.

(51) Int. Cl. G06F 30/20; G06F 111/10; G06F 113/04

(52) U.S. Cl. CPC G06F 30/20; G06F 2111/10; G06F 2113/04

(57) ABSTRACT

A computer implemented process/method is provided, which creates a distribution digital twin replicating electrical distribution grid dynamic behavior in actual-time. In some embodiments, the disclosed system and methods facilitate the calculation of an actual time virtual dynamic behavior representation of the distribution electric grid, which considers a dynamic model for the distribution electric grid system components. The distribution system components consider traditional generation and load assets as well as any dynamic demand response and distributed energy resources know in the art. The proposed systems and methods may utilize pre-configured constraints and parameters in conjunction with the receipt of real time grid parameters and control updates to calculate dynamic simulation of the distribution grid in actual time. Said dynamic simulation of the distribution grid can be saved to computer data storage for use by end users for any means known in the art.

### CROSS-REFERENCE TO RELATED APPLICATIONS

This application claims priority to provisional application No. 63/560,018, filed Mar. 1, 2024, the entire contents of which are incorporated by reference.

### OTHER PUBLICATIONS

Kundur, Prabha, “Power System Stability and Control (EPRI Power System Engineering Series),” (1994)

### STATEMENT REGARDING FEDERALLY SPONSORED RESEARCH

Not Applicable.

### FIELD OF THE INVENTION

The present disclosure relates generally to systems and methods creating a distribution digital twin replicating electrical distribution grid dynamic behavior in actual-time (herein referred to as “D2T”). In some embodiments, D2T may be consumed by another application as an actual-time dynamic distribution operator training simulator. D2T considers dynamic models for all distribution components including but not limited to emerging technologies, Distributed Energy Resources (hereafter referred to as “DERs”) and their inverters, other generation resources and demand loads. The D2T can be integrated, in some embodiments, to other distribution applications, such as but not necessarily limited to, DERMS, microgrid management system, and ADMS.

### BACKGROUND OF THE INVENTION

Distribution operators can utilize virtual representations or models of the physical electrical grid to simulate the electrical grid's behavior and performance updated in short periodicities (e.g. time intervals of 2-4 seconds). These previously existing models are limited in their ability to recreate system performance, relying on the static characteristics of the system and do not take into account the dynamic behavior of the distribution components installed within today's distribution grid. Such static models use algebraic equations, or so called power flow methods, to perform periodic calculations in order to establish system condition solutions, which fail to reflect the actual time dynamic behavior of today's distribution system that include DERs, inverters, and other dynamic changing components. Many virtual representations of the electric grid known today are not organized or flexible enough to include this dynamic modeling and simulation capability to replicate accurately in real-time the behavior of today's distribution system which includes dynamic components such as but not necessarily limited to emerging technologies and distributed generation, their inverters and other distribution control systems alongside traditional generation sources when providing solutions for the distribution operator.

The current disclosure relates, in at least one embodiment, to the creation of a virtual representation of the electrical grid in real time, which accurately considers the dynamic characteristics of distribution components including but not necessarily limited to emerging technologies and distributed generation, their inverters and other distribution control systems.

### SUMMARY OF THE INVENTION

In general, this disclosure is directed toward replicating electrical distribution grid dynamic behavior in actual time. In particular, the present disclosure relates to such a virtual representation (or model) of the electric distribution grid that dynamically addresses in real-time the contributions from traditional generation and loads as well as the multitude of today's distributed electric resources that are becoming more and more prevalent. In general, this disclosure is directed toward systems and methods that utilize data inputs from multiple sources and advanced computing methods to produce distribution grid performance results in actual-time, which, in some embodiments, can be sub-second intervals. In some embodiments, the inventive system and methods can be integrated to other solutions known in the art, such as, but not necessarily limited to, Distributed Energy Resource Management system (hereafter referred to as “DERMS”), microgrid management system, and Advanced Demand Management System (hereafter referred to as “ADMS”), to create a dynamic operator training simulator for the integrated solution.

In some embodiments, virtual representations of the distribution grid can be formulated for distribution operator use in a way that nearly synchronizes the output of the model with the real time distribution grid conditions. These methods and system can utilize (1) a study case, (2) system configurations, including simulation scenarios fed into (3) a dynamic simulation engine to provide system behavior and (4) provide operator interactions through over-ride controls, (5) provide a result visualization that (6) can be stored to a system data storage method, such as a database, and then (7) passed to any integration tool known in the art, to (8) provide the result of the distribution grid dynamic simulation to a consuming system, such as, but not necessarily limited to, a DERMS, and ADMS, or a Microgrid Management System. The solution result of the virtual representation of the distribution grid may be passed to a DERMS, ADMS, or Microgrid operator to act as a Real-time Operator Training Simulator for any such the integrated system. The systems and methods of the present invention enable these operators to analyze distribution grid conditions for optimization and prediction of how the electric grid will function, which can be useful for, among other uses, demand optimization, system testing, and any other use known in the art.

The invention may take the form of a computer-implemented system utilizing a processor, data storage, and specific functions performed by the computer for creating a simulation result reflecting a virtual representation of the distribution electric grid, configured to:
Receive initial distribution grid data,
Identify case management parameters,
Enter system configurations,
Calculate an initial simulation result utilizing said initial grid data, case management parameters, and system configurations using a computer processor to operate a simulation engine,
Store said initial simulation result in a computer database,
Receive updated distribution grid data,
Receive operator override controls,
Calculate an updated simulation result utilizing said updated distribution grid data, case management parameters, system configuration and operator override controls, using a computer processor to operate said simulation engine,
Store said updated simulation result in computer memory or database.

The invention may also include a computer-implemented method utilizing a processor, data storage, and specific functions performed by the computer to create a simulation result reflecting a virtual representation of the distribution electric grid by:
Receiving initial distribution grid data,
Identifying case management parameters,
Entering system configurations,
Calculating an initial simulation result utilizing said initial grid data, case management parameters, and system configurations using a computer processor to operate a simulation engine,
Storing said processed simulation result in a computer database,
Receiving updated distribution grid data,
Receiving operator override controls,
Calculating an updated simulation result utilizing said updated distribution grid data, case management parameters, system configurations, and operator override controls using a computer processor to operate said simulation engine,
Storing said updated simulation result in computer memory or database.
   The details of one or more aspects of the disclosure are set forth in the accompanying drawings and the description below. Other features, objects, and advantages will be apparent from the description and drawings, and from the claims.

### BRIEF DESCRIPTION OF DRAWINGS

FIG. 1 is a flow chart illustrating an example of how the components of the systems and methods may interact to calculate a model of the distribution electric grid.

### DETAILED DESCRIPTION OF THE INVENTION

While this invention may be embodied in many forms, there are specific embodiments of the invention described in detail herein. This description is an exemplification of the principles of the invention and is not intended to limit the invention to the particular embodiments illustrated.

In general, this disclosure is directed toward actual-time virtual representation of the electric distribution grid including traditional and dynamic components. The penetration of DERs and their inverter based control systems along with other fast-acting resources and controllers have transformed the electric distribution system from a passive, slow-response system to a dynamic, fast-acting system. Presently, real-time distribution applications such as Distribution Management Systems (herein referred to as “DMS”) and ADMS operator training simulators, which are intended to recreate the behavior of the distribution system in real-time, use static models ignoring dynamic behavior of the distribution components. Static models use algebraic equations, or so called power flow methods, to perform periodic calculations on intervals of approximately every 2-4 seconds to establish system conditions.

In the system and methods of the current disclosure, accurate distribution system dynamic behavior is replicated in actual time utilizing data inputs, such as but not necessarily limited to, electric distribution system component dynamic models and model parameters known in the art. If the dynamic model is not available for a component, then a custom model needs to be created based on the specification of the distribution component through methods know in the art. These distribution component dynamic models along with their parameters for distribution network components, are collectively referred to as Case Management [101]. Distribution network components may include data from DERs and their inverter control systems, as well as any other data from fast acting resources and controllers known in the art. In some embodiments, a Case Management [101] may be further comprised of data models of specific system components such as, but not necessarily limited to, generators, governors, excitation systems and any other similar systems or devices known in the art. A Simulation Engine [107] can be any advanced dynamic simulation software known in the art capable of 1) assembling all the distribution system component dynamic models together and 2) solving the differential equations and the algebraic equation associated with all the system component models simultaneously to replicate the system dynamic behavior in sub-second-seconds intervals. In a non-limiting example, some embodiments may utilize innovative hardware solutions known in the art, such as but not necessarily limited to, clustering, distributed processing and parallel processing for the purposes of expediting the Simulation Engine [107] performance. In another non-limiting example, some embodiments may utilize software methodologies known in the art, such as but not necessarily limited to, multi-processing for the purposes of expediting the Simulation Engine [107] performance. The Actual-time refers to the state of the physical electrical distribution system and the results created by the proposed system and methods being closely synchronized in real-time. The distribution dynamic system model is composed of a multitude of distribution component dynamic models. The disclosed system and methods may utilize any process know in the art for developing models for system components, assembling such models and solving the differential and algebraic equations for creating a dynamic simulation.

Due to the complexity of the distribution system component dynamic models, and their smaller simulation time steps requirement to accurately reflect the dynamic behavior in actual time, the dynamic model simulation demands a much higher computation power than that of existing virtual representations or models of the physical electrical grid using static models. The current disclosure may achieve additional modeling computation requirements using appropriate innovative software development such as but not limited to multi-processing and effective hardware solution techniques such as but not limited to clustering, distribution processing and parallel processing.

In the preferred embodiment, the disclosed system and methods may utilize specific functions performed by computer systems having processors and data storage. In particular, the present disclosure relates to a virtual dynamic representation (or dynamic model) of the electric distribution grid that replicates the dynamic behavior of distribution system components in actual-time including those from the multitude of distributed electric resources and their inverters that are becoming more and more prevalent.

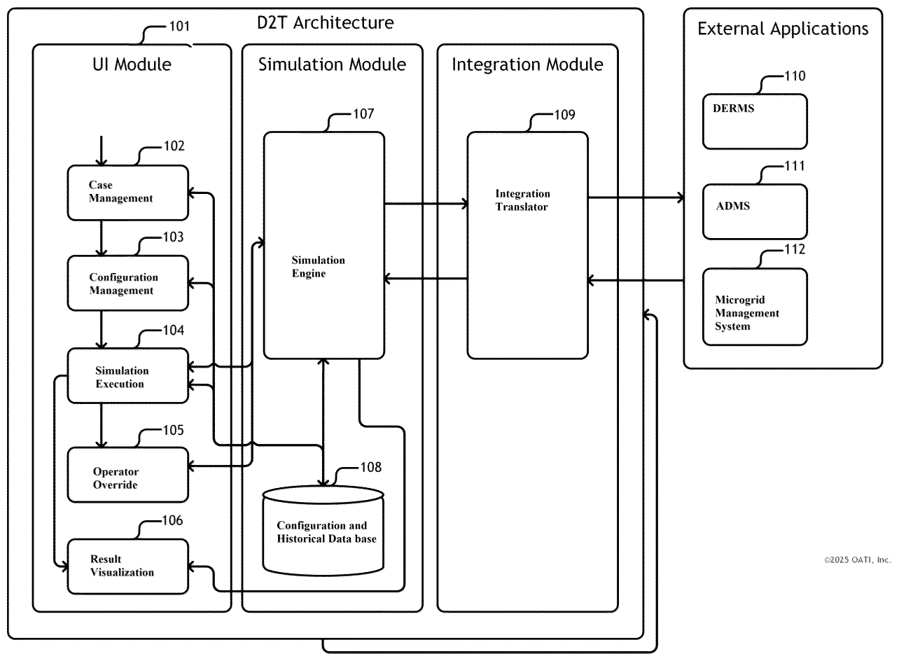

Referring to FIG. 1, which is a flow chart illustrating an example of how the components of the disclosed systems and methods may interact to create the virtual representation of the dynamic behavior of the electric distribution grid. A User Interface module [101] (used herein as “UI module”) may, in preferred embodiments, be utilized to organize the data flow and action logic described in the present disclosure, as well as facilitate the flow of data from one component of the systems and methods to others. The case management [102] allows a distribution operator to either create a new study case or use an existing case. Study case refers to the distribution grid topology model, resources models, DERs and their inverters as well as controls associated to a particular distribution system for which a simulation result is sought using the disclosed systems and methods. In a non-limiting example, an operator may need to create a study case for a utility distribution system in California whereas another operator may need to provide a D2T for a utility distribution system in Washington. To create a new study case, the user is prompted to enter initial distribution data such as, but not necessarily limited to, a distribution grid topology model, resources models, DERs and their inverters as well as controls. The disclosed system and methods are comprised of one or many configurable parameters as Configuration Management [103]. The Configuration Management [103] parameters are comprised of, but not necessarily limited to, telemetry and control, displays, projected solar and load profiles, simulation and scenario builder parameters. In some embodiments, Configuration Management [103] parameters may also control aesthetic display components as well as any simulation parameters of the system and methods described herein, such as the length of simulation execution time. Simulation Execution [104] may control the delivery of Case Management [102], Configuration Management [103] and any Operator Overrides [105] to the dynamic Simulation Engine [107] for assembling the dynamic models and solving their corresponding differential and algebraic equations to create the dynamic simulation result. The resulting simulation result may be stored to any computer data storage [108] known in the art. In some embodiments, simulation results may be displayed on a computer visualization display [106]. Operator Override [105] provide operator control actions changing system controls and parameters during the simulation execution loops. These Operator Override [105] changes are transmitted to the dynamic Simulation Engine [107] when they occur. In some embodiments, simulation results stored in computer data storage [108] may be updated across time through the creation of a process loop, allowing for updated Operator Override [105] and any updated Case Management [102] of Configuration Management [103] data to be delivered to the Simulation Engine [107] for assembling updated dynamic models and solving their corresponding differential and algebraic equations to create an updated dynamic simulation result. Such updated simulation result may then be stored to any computer data storage [108] known in the art. In some embodiments, updated simulation results may be displayed on a computer visualization display [106].

In some other embodiments, the disclosed system and methods may utilize any integration tool [109] known in the art as a data conversion, communication bus data exchange module to export the said simulation result from the computer data storage [108] or from the Simulation Engine [107] to external applications, such as, but not necessarily limited to, a DERMS system [110], ADMS system [111], or a Microgrid Management System [112], to create a real-time dynamic Operator Training Simulator or a real-time assessment tool for such simulation results. In these embodiments, the external DERMS system [110], ADMS system [111], or Microgrid Management System [112] may receive telemetry of the simulation result and may send controls to the Simulation Engine [107] via the Integration Translator [109].

In a non-limiting example, the disclosed systems and methods may be additionally comprised of configurable system overrides [105]. Such configurable system overrides [105] are, in preferred embodiments, computer implemented software logic controls that may control simulation calculation execution times, certain execution strategies such as but not necessarily limited to changes in topology, changes in resource active and reactive power set points, or changes in battery set points and other controls to reflect changes that the operator may want to make during the study period.

1. A computer-implemented system utilizing a processor, data storage, and specific functions performed by the computer for creating a virtual dynamic representation of the distribution electric grid, configured to:
a. Receive initial distribution grid data,
b. Identify case management parameters,
c. Enter system configurations,
d. Enter initial operator overrides,
e. Calculate an initial simulation result utilizing said initial grid data, case management parameters, system configurations, and initial operator override controls using a simulation engine,
f. Store said initial simulation result in a computer database.

2. The system of claim 1, wherein updated distribution grid data and updated operator override controls are received and utilized along with case management parameters, system configuration to calculate an updated simulation result using said simulation engine.

3. The system of claim 1, wherein said initial distribution grid data is comprised of data from DERs and their inverter control systems, as well as any other data from fast acting resources and controllers known in the art.

4. The system of claim 1, wherein said simulation engine solves algebraic and differential power flow equations.

5. The system of claim 1, wherein said initial simulation results are output to any computer enabled system known in the art.

6. The system of claim 1, wherein configurable system overrides control simulation calculation execution times, execution strategies, or execution times and execution strategies.

7. A computer-implemented method utilizing a processor, data storage, and specific functions performed by the computer to create a virtual dynamic representation of the distribution electric grid by,
a. Receiving initial distribution grid data,
b. Identifying case management parameters,
c. Entering system configurations,
d. Entering initial operator override controls,
e. Calculating an initial simulation result utilizing initial distribution grid data, case management parameters, system configurations, and initial operator override controls using a simulation engine,
f. Storing said calculated initial simulation result in a computer database.

8. The method of claim 7, wherein updated distribution grid data and updated operator override controls are received and utilized along with case management parameters, system configuration to calculate an updated simulation result using said simulation engine.

9. The method of claim 7, wherein said initial distribution grid data is comprised of data from DERs and their inverter control systems, as well as any other data from fast acting resources and controllers known in the art.

10. The method of claim 7, wherein said simulation engine solves algebraic and differential power flow equations.

11. The method of claim 7, wherein said initial simulation results are output to any computer enabled system known in the art.

12. The method of claim 7, wherein configurable system overrides control simulation calculation execution times, execution strategies, or execution times and execution strategies.
